(19) United States
(12) Patent Application Publication
(10) Pub. No.: US 2012/0266857 A1
(43) Pub. Date: Oct. 25, 2012

(54) BARBEQUE GRILL LIFT COVER STRUCTURE

(76) Inventor: Chuan-Yi LIN, Fuxing Township (TW)

(21) Appl. No.: 13/090,698

(22) Filed: Apr. 20, 2011

(51) Int. Cl. A47J 37/00

(52) U.S. Cl. 126/25 R

(57) ABSTRACT

The present invention discloses a barbeque grill lift cover structure comprising a combining base disposed separately at corresponding positions on both sides of the body, and a pair of link rods installed with an interval apart and at rear laterals of the combining base, and another end of the link rod is pivotally coupled to both sides of the cover separately to constitute the barbeque grill lift cover structure of the invention, and the link rods at both sides of the body and the cover can be pivotally coupled, such that when the cover is lifted open, the link rods are pivotally turned and guided to achieve a smooth lifting movement and maintain the lift cover stably.

### BACKGROUND OF THE INVENTION

1. Field of the Invention

The present invention relates to a barbeque grill lift cover structure, and more particularly to a barbeque grill lift cover structure designed to meet the requirement of lifting open a cover of a BBQ grill smoothly and stably by pivotal turning and guidance of link rods that are pivotally coupled to both sides of the body and the cover.

2. Description of the Prior Art

Barbeque (BBQ) is a popular outdoor activity, not only allowing us to taste food with a different cooking style, but also providing a social activity. People usually conduct the BBQ activity with friends and family on a whim. A conventional simple BBQ grill comes with a simple structural design and fails to meet the frequent use requirement, and such simple BBQ grill may be damaged after a few time of use. Although the price is low, the simple BBQ grill is not suitable for heavy users, and its economic value is not as good as a high-price BBQ grill. The high-price BBQ grill usually integrates a wheel, an object placing board, a storage rack, a cover and other peripherals, in addition of the basic BBQ function, in order to provide more value-added functions to the product and promote the sales of the product.

The cover of the BBQ grill of this sort generally adopts a detachable design, so that it is necessary to lift the cover and put it aside, when the cooking food materials are placed or turned over. After the related cooking processes are completed, the cover is put back onto the body again, thus requiring repeating the operation of lifting and covering the cover very often and causing tremendous trouble and inconvenience to users. Furthermore, the cover may be dropped, damaged, and stained easily by accident, and the cover heated for a long time may even burn the users accidentally. Obviously, the conventional cover structure requires improvements.

### SUMMARY OF THE INVENTION

In view of the problem and drawback of the conventional BBQ grill with a fully lifted opened cover, the inventor of the present invention based on years of experience in the related industry to conduct extensive researches and experiments, and finally developed a lift cover that can be lifted open, while maintaining the cover from not separating the body completely, such that users can access food materials and turn cooking food easily, as well as preventing the cover from falling off.

Another objective of the present invention is to provide a structural design of a lift cover, such that the lift cover can be opened and covered smoothly, while maintaining the lifted open status of the cover stably.

To achieve the foregoing objectives, the present invention provides a structural design of a barbeque grill lift cover structure, and the barbeque grill lift cover structure comprises a combining base disposed separately at corresponding positions on both sides of the body, and a pair of link rods installed with an interval apart and at rear laterals of the combining base, and another end of the link rod is pivotally coupled to both sides of the cover separately to constitute the barbeque grill lift cover structure of the invention, and the link rods at both sides of the body and the cover can be pivotally coupled, such that when the cover is lifted open, the link rods are pivotally turned and guided to achieve a smooth lifting movement and maintain the lift cover stably.

### BRIEF DESCRIPTION OF THE DRAWINGS

FIG. 1 is a schematic perspective view of a lift cover at a closed status in accordance with a preferred embodiment of the present invention;

FIG. 2 is a schematic perspective view of a lift cover at a lifted open status in accordance with a preferred embodiment of the present invention;

FIG. 3 is a partial exploded view of a preferred embodiment of the present invention;

FIG. 4 is a partial perspective view of a preferred embodiment of the present invention; and

FIG. 5 is a schematic view of the movements of lifting open a cover in accordance with a preferred embodiment of the present invention.

### DETAILED DESCRIPTION OF THE PREFERRED EMBODIMENTS

The technical characteristics and effects of the present invention will become apparent with the detailed description of the preferred embodiment together with the illustration of related drawings as follows.

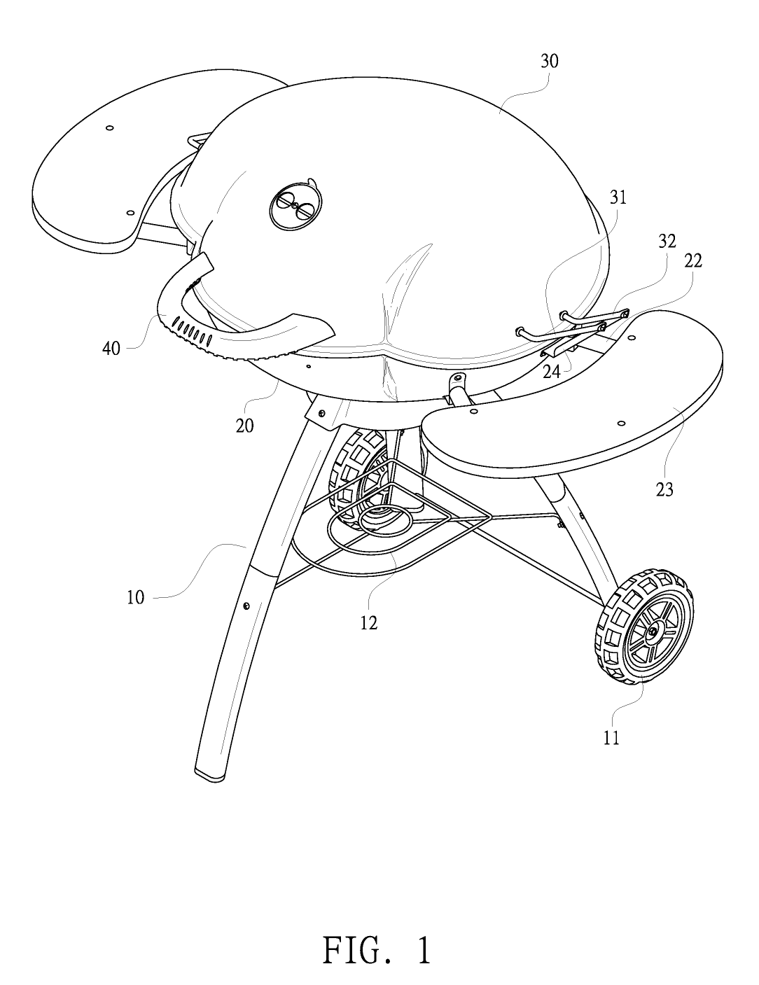

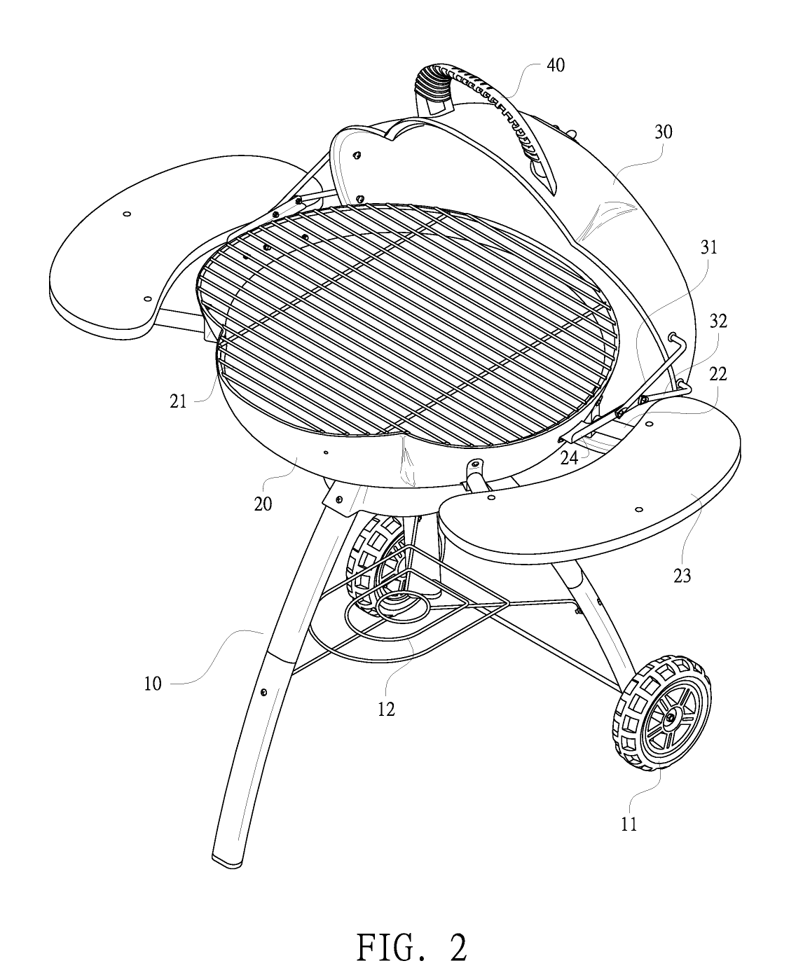

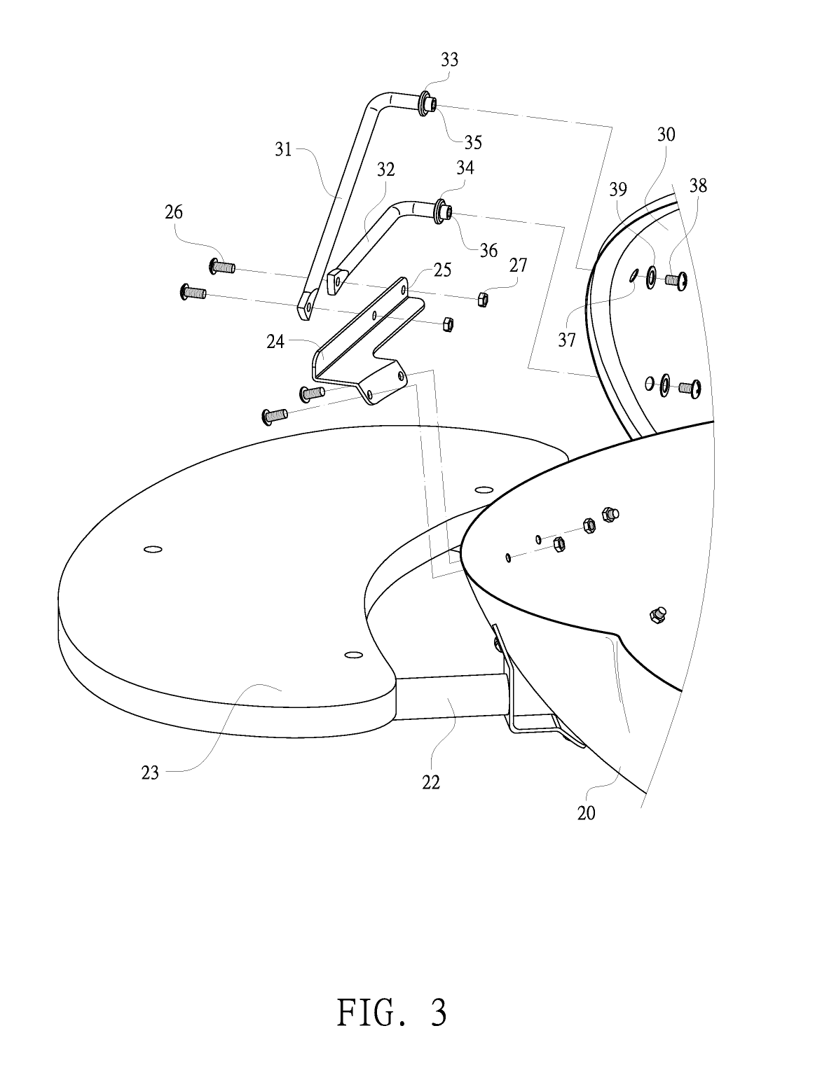

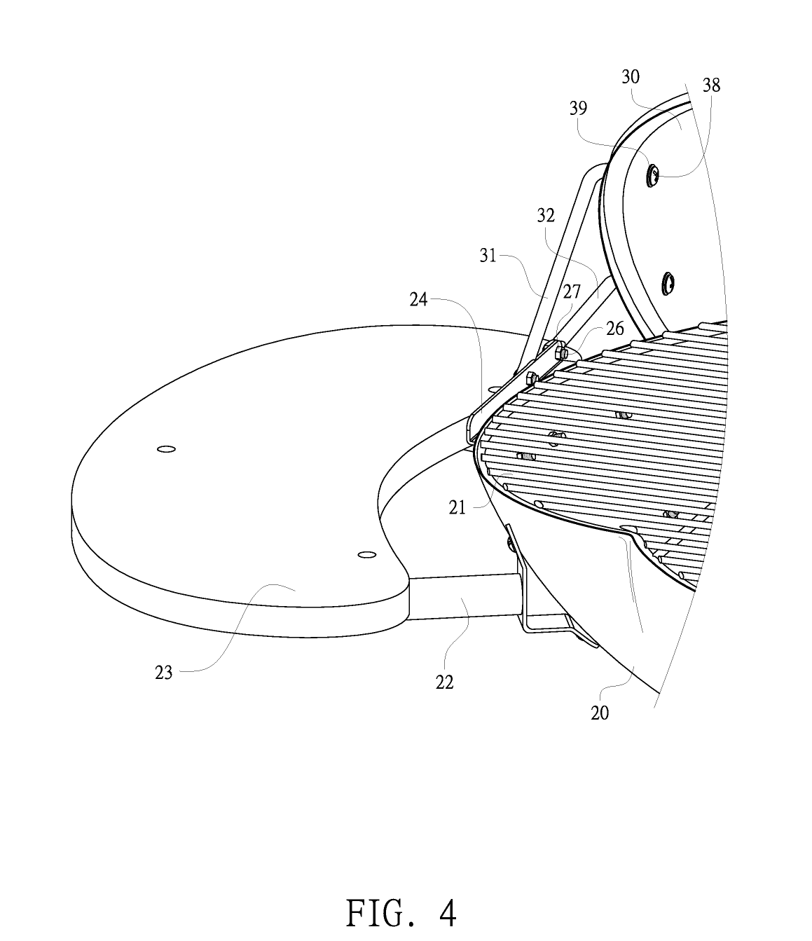

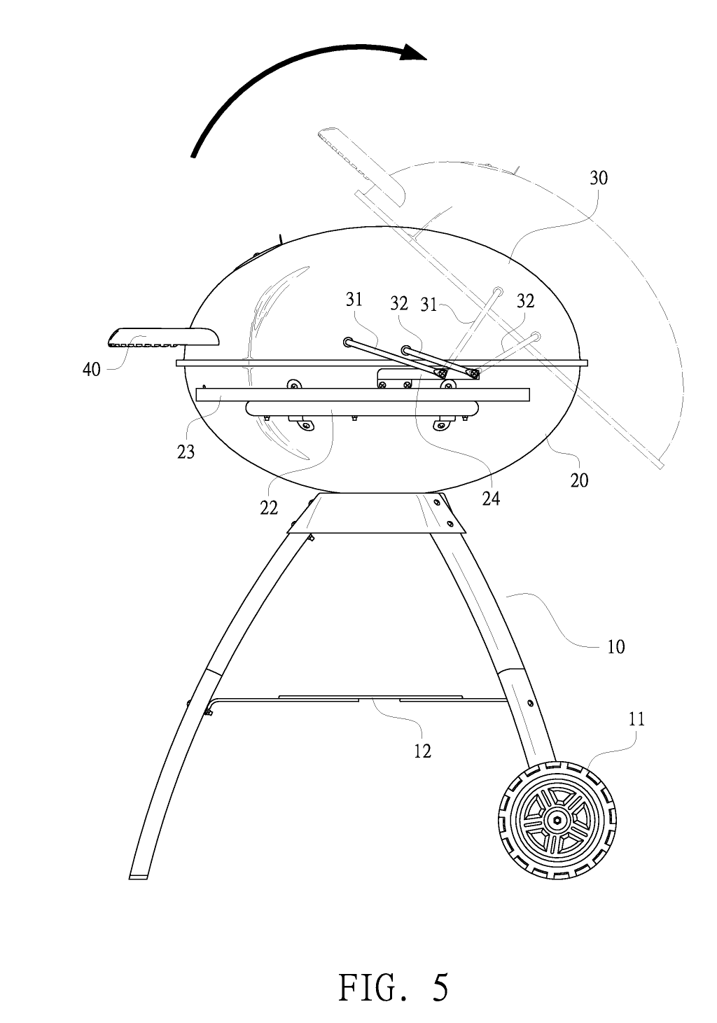

With reference to FIGS. 1 and 2 for schematic views of a lift cover at closed and lifted open statuses respectively, FIGS. 3 and 4 for a partial exploded view and a partial perspective view of the lift cover structure respectively, and FIG. 5 for a schematic view of the movements of lifting open the lift cover in accordance with a preferred embodiment of the present invention, a BBQ grill of the preferred embodiment comprises a movable grill stand 10, a wheel 11 installed at a predetermined position of the grill stand 10 for providing an appropriate moving function, a storage rack 12 installed at a predetermined position of the grill stand 10, a body 20 having a predetermined stylish appearance and mounted to the top of the grill stand 10 and supported by the grill stand 10, a barbeque net 21 installed in the body 20 and with a predetermined height from the bottom of the barbeque net 21 for supplying charcoals, an object placing board 23 installed on both sides of the body 20 by a side frame 22 and provided for placing food materials or sources, and barbeque tools such as tongs and brushes, and a cover 30 covered onto the top of the body 20 and having a shape matched with the shape of the body 20 and providing a lifted open function of the cover 30. With the aforementioned components, the basic functional structure of the BBQ grill is achieved. As to the connection between the body 20 and the cover 30, a combining base 24 is disposed at positions on both sides of the body 20 separately, and a pair of bolt holes 25 are formed at rear positions of a vertical board of the combining base 24, and the pair of the bolt holes 25 together with a bolt 26 and a nut 27 are used for pivotally connecting a pair of link rods 31, 32, wherein the link rods 31, 32 are arranged in an L-shape, and include a front link rod 31 and a rear link rod 32, and the front link rod 31 is longer than the rear link rod 32, and stop ring 33, 34 are installed at end positions of a turning section of the link rods 31, 32 respectively, and screw holes 35, 36 are formed at the end positions, and a pair of through holes 37 are formed at predetermined positions on both sides of the cover 30 for passing the ends of the turning section of the link rods 31, 32 through the through holes 37, and then a bolt 38 and a washer 39 are used for securing the ends of the link rods 31, 32 from the internal side of the cover 30, such that both ends of the link rods 31, 32 and the combining base 24 for pivotally turning the cover 30 and the body 20 constitute a pivotal connecting relation. Further, a handle 40 is designed at the front of the cover 30 and provided for lifting or covering the cover 30, such that the position limiting guidance formed at both sides of the link rods 31, 32 allows the cover 30 to be lifted open and covered smoothly and stably. After the cover 30 is lifted open fully, the link rods 31, 32 can maintain the lifted open status of the cover 30 to facilitate the operations of accessing food materials, turning the cooking food, and saucing the cooking food, without worrying about the cover that may be fallen off or damaged, or getting dirty.

With the description above, the structural design of the BBQ grill of the present invention uses the pair of the link rods for pivotally coupling the body and the cover without affecting the lifted open function of the cover, and the position limiting guidance of the link rods on both sides allows the cover to be pivotally turned with the link rods to achieve smooth and stable operations, and maintain the cover from not separating from the body completely, so as to save the trouble and inconvenience of putting the lifted cover at a particular place and prevent the cover from falling off, being damaged and getting dirty. Overall speaking, the lift cover structure of the present invention can improve the utility and convenience of the BBQ grill.

In summation of the description above, the barbeque grill lift cover structure of the present invention can overcome the problem and drawback of the conventional cover structure that the cover and the body may be separated easily. The invention uses the pair of link rods on both sides of the body as components for pivotally connecting the body with the cover, such that the cover can be lifted open or covered smoothly and stably, and the cover can be maintained at the lifted open status without affecting the operations of accessing food materials and turning over the cooking food, so as to improve the overall utility and convenience of the BBQ grill. in addition, the present invention complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A barbeque grill lift cover structure, comprising:
a body; and
a cover, wherein the cover having a shape matched with and fully covering the body, and
a handle formed at the top of the cover and provided for lifting open the cover,
characterized in that the body comprising a combining base disposed separately at corresponding positions on both sides of the body, and a pair of bolt holes formed at predetermined positions of a vertical board of the combining base and provided for pivotally coupling a pair of link rods on both sides of the body respectively, and another end of the link rod being pivotally coupled to both sides of the cover, thereby the link rods at both sides of the body can be turned pivotally to lift open and cover the cover smoothly and stably.

2. The barbeque grill lift cover structure of claim 1, wherein the link rods are pivotally and respectively coupled to rear lateral positions of the vertical boards on both sides of the combining base.

3. The barbeque grill lift cover structure of claim 1, wherein the link rods on both sides of the body include a front link rod and a rear rod, and the front link rod has a length longer than the rear link rod.

4. The barbeque grill lift cover structure of claim 1, wherein the link rods on both sides of the body are arranged in an inverted L-shape, and a stop ring is installed at a position proximate to an end of the turning section, and a through hole is formed at a corresponding predetermined position of the cover, such that the end of the turning section of the link rods can be passed through the through hole of the cover to achieve the pivotal coupling relation and provide a sufficient space for pivotally turning the link rods and the cover.

5. The barbeque grill lift cover structure of claim 1, wherein the body is installed at the top of a grill stand, and the grill stand has a wheel for moving the BBQ grill easily.
